(19) United States
(12) Patent Application Publication
(10) Pub. No.: US 2012/0091641 A1
(43) Pub. Date: Apr. 19, 2012

(54) AIR PRESSURE BUFFER

(76) Inventor: Ching-Chuan YANG, Taipei County (TW)

(21) Appl. No.: 12/907,779

(22) Filed: Oct. 19, 2010

(51) Int. Cl. F16F 11/00; F16F 13/00

(52) U.S. Cl. 267/140.13; 188/271

(57) ABSTRACT

An air pressure buffer includes a hollow tube, a first cap at one end of the tube, a shaft including a first section, a second section and a third section with the first section and/or third section extended outside the tube, a flexible valve which has an annular recess at one side to form an open space with the tube and second section extended to the third section and another side facing the first cap to form a closed space with the tube, the first cap and the second section extended to the first section, and a flexible compression member which has at least one axial ventilation groove on the outer surface thereof. The structure thus formed does not have buffer delay while being applied by an external force and provides enhanced buffer damping capability and steady and secure buffering effect.

### FIELD OF THE INVENTION

The present invention relates to a buffer for household hardware and particularly to an air pressure buffer that uses air pressure for damping.

### BACKGROUND OF THE INVENTION

In early days, pliable rubber pads or elastic springs and reeds are generally adopted to be buffers to avert direct impact of objects to reduce shock and noise. However, as used in houses to cushion impact, such as closing doors against door frames or pushing drawers into cabinets, a buffer usually is employed to reduce closing speed and impact. Applicant has disclosed an air pressure hinge in P.R.C. patent No. CN2685495Y. Refer to FIGS. 3 and 4 in this prior art, it includes an air cylinder and a telescopic cylinder axle with one end exposed outside that has an axle hole formed thereon and a hinge portion run through by a first pivot to be hinged on a butting member. The cylinder shaft has another end coupled with a regulation valve made of plastics or rubber. The regulation valve has an outer wall formed at a greater thickness in the center and thinner at two sides. When the cylinder shaft runs into the air cylinder, the outer wall of the regulation valve moves along the inner wall of the air cylinder and consumes less force. When the cylinder shaft is extended out of the air cylinder, the regulation valve moves reversely along the inner wall of the air cylinder and the thinner portions at two sides of the regulation valve are extended, hence is consumed greater force. As a result, buffer delay frequently takes place when the air cylinder is subject to external forces, and unstable pause conditions could occur during the cylinder shaft is undertaken buffering, thus the prior art provides limited buffering effect and could result in unsecured or inaccurate positioning.

### SUMMARY OF THE INVENTION

The primary object of the present invention is to overcome the aforesaid shortcomings by providing an air pressure buffer to prevent buffer delay when external force is applied, enhance damping capability and generate steady buffering effect.

To achieve the foregoing object, the air pressure buffer according to the invention includes a hollow tube, a first cap located at one end of the tube, a shaft running through the tube and having a first section, a second section and a third section with the first section and/or third section extended outside the tube, and a flexible valve held in the tube and surrounding the second section in an annular manner. The flexible valve has an outer diameter the same as the inner diameter of the tube and an outer surface in contact with the inner wall of the tube in a sliding fashion, and an inner diameter the same as the outer diameter of the second section and an inner surface confined to be slid on the shaft surface of the second section. The valve also has an annular recess at one side to form an open space with the tube and the second section extended to the third section, and another side facing the first cap. The valve, tube, first cap and the second section extended to the first section form a closed space. The air pressure buffer of the invention further includes a flexible compression member held in the closed space and surrounding the second section in an annular manner. The compression member is formed at an outer diameter the same as the inner diameter of the tube, and has an outer surface in contact with the inner wall of the tube in a sliding manner. The compression member is formed at an inner diameter the same as the outer diameter of the second section, and has an inner surface confined to be slid on the shaft surface of the second section. The compression member further has at least one axial ventilation groove formed on the outer surface thereof.

Compared with the conventional techniques, the structure of the invention set forth above provides many benefits, notably: 1. the air pressure buffer of the invention prevents buffer delay when applied by external forces; 2. the air pressure buffer of the invention enhances buffer damping capability and generates secured and steady buffering effect.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is an exploded view of a first embodiment of the invention.

FIG. 2 is a schematic view according to FIG. 1 in an assembly condition.

FIGS. 3A through 3C are sectional views according to FIG. 1 in continuous moving conditions.

FIGS. 4A through 4C are sectional views according to FIG. 1 in continuous moving conditions with a compression spring installed in the closed space.

FIG. 5 is an exploded view of a second embodiment of the invention.

FIG. 6 is a schematic view according to FIG. 5 in an assembly condition.

FIGS. 7A through 7C are sectional views according to FIG. 5 in continuous moving conditions.

FIGS. 8A through 8C are sectional views according to FIG. 5 in continuous moving conditions with a compression spring installed in the closed space.

FIG. 9 is an exploded view of a third embodiment of the invention.

FIGS. 10A through 10C are sectional views according to FIG. 9 in continuous moving conditions.

FIGS. 11A through 11C are sectional views according to FIG. 9 in continuous moving conditions with a compression spring installed in the closed space.

FIGS. 12A and 12B are sectional views of a fourth embodiment of the invention in continuous moving conditions.

FIGS. 13A and 13B are sectional views according to FIGS. 12A and 12B in continuous moving conditions with a compression spring installed in the closed space.

FIGS. 14A and 14B are sectional views of a fifth embodiment of the invention in continuous moving conditions.

FIGS. 15A and 15B are sectional views of a sixth embodiment of the invention in continuous moving conditions.

### DETAILED DESCRIPTION OF THE PREFERRED EMBODIMENTS

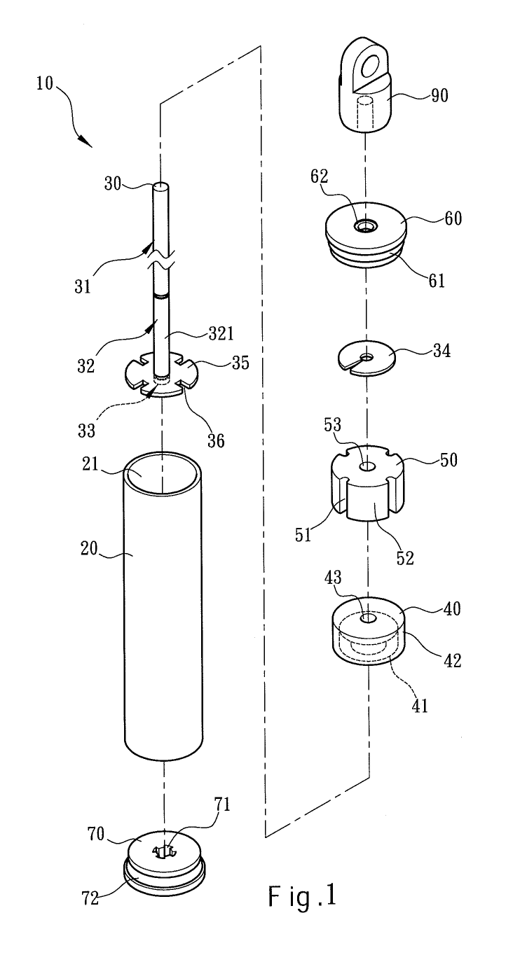

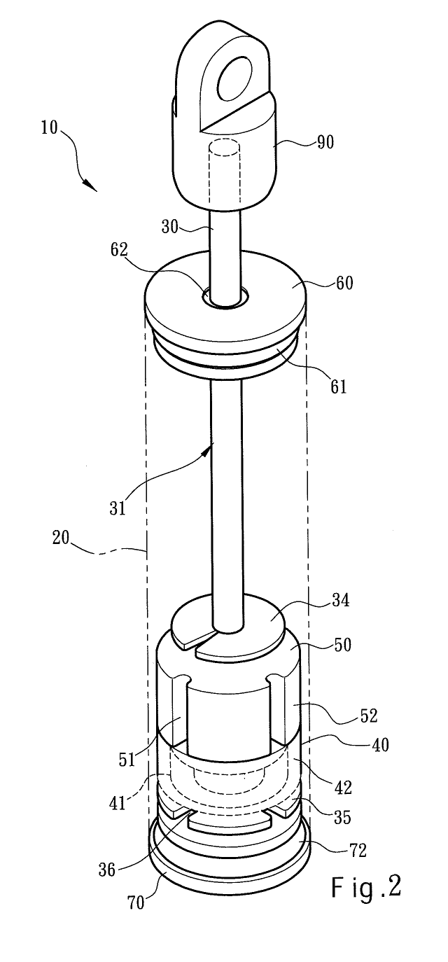

Please refer to FIGS. 1, 2, 3A through 3C for a first embodiment of the invention. The air pressure buffer 10 according to the invention includes a hollow tube 20, a first cap 60 located at one end of the tube 20 that has a flexible first seal ring 61 made of rubber to tightly connect with the tube 20, and a shaft 30 running through the tube 20 and including a first section 31, a second section 32 and a third section 33. The first section 31 is extended outside the tube 20. The first cap 60 has a flexible second seal ring 62 made of rubber to tightly connect with the first section 31. The first section 31 has a distal end extended outside the tube 20 to fasten to a connector 90. The tube 20 holds a flexible valve 40 inside which surrounds the second section 32 in an annular manner. The valve 40 has an outer diameter the same as the inner diameter of the tube 20 and an outer surface 42 in contact with an inner wall 21 of the tube 20 in a sliding manner. The valve 40 has an inner diameter the same as the outer diameter of the second section 32, and also an inner surface 43 confined to be slid on a shaft surface 321 of the second section 32. The valve 40 further has one side with an annular recess 41 formed thereon to form an open space 23 with the tube 20 and the second section 32 extended to the third section 33, and another side facing the first cap 60. The valve 40, tube 20, first cap 60 and second section 32 extended to the first section 31 form a closed space 22. The invention further includes a flexible compression member 50 held in the closed space 22 and surrounding the second section 32 in an annular manner. The compression member 50 has an outer diameter the same as the inner diameter of the tube 20 and an outer surface 52 in contact with the inner wall 21 of the tube 20 in a sliding manner. The compression member 50 also has an inner diameter the same as the outer diameter of the second section 32 and an inner surface 53 confined to be slid on the shaft surface 321 of the second section 32. The compression member 50 further has at least one axial ventilation groove 51 on the outer surface 52 thereof. The tube 20 further has another end coupled with a second cap 70 which has a flexible third seal ring 72 made of rubber to tightly connect with the tube 20. The second cap 70 also has at least one aperture 71 to allow the open space 23 to communicate with outside of the tube 20. The shaft 30 has a first retaining member 34 annularly formed between the first section 31 and second section 32. The first retaining member 34 is formed at an outer diameter smaller than the outer diameter of the compression member 50, and greater than or equal to the outer diameter of the first section 31. The shaft 30 also has a second retaining member 35 annularly formed between the second section 32 and third section 33. The second retaining member 35 is formed at an outer diameter smaller than the outer diameter of the valve 40, and greater than or equal to the outer diameter of the third section 33. The second retaining member 35 has at least one notch 36 to allow the recess 41 to communicate with the outside of the tube 20.

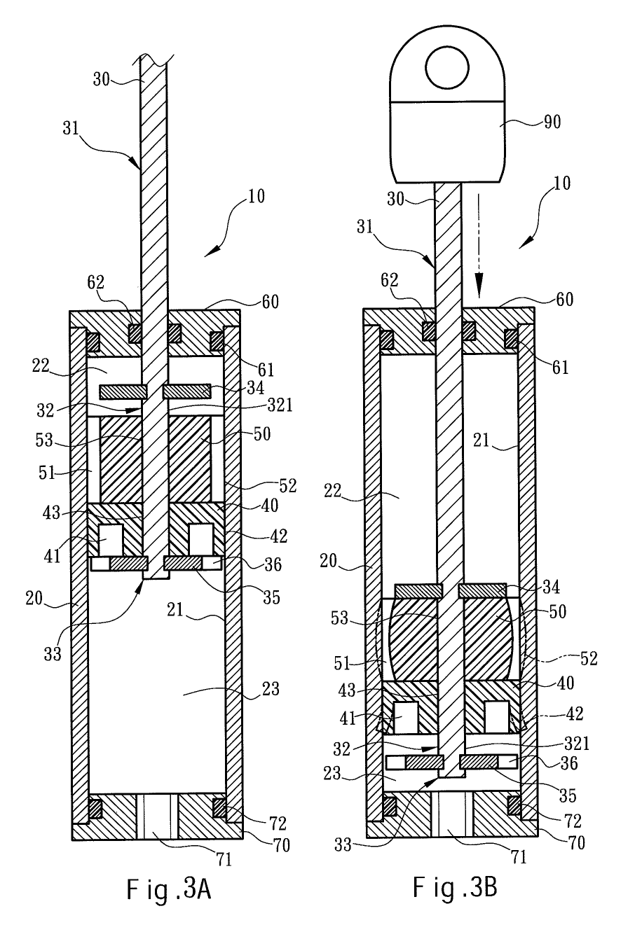

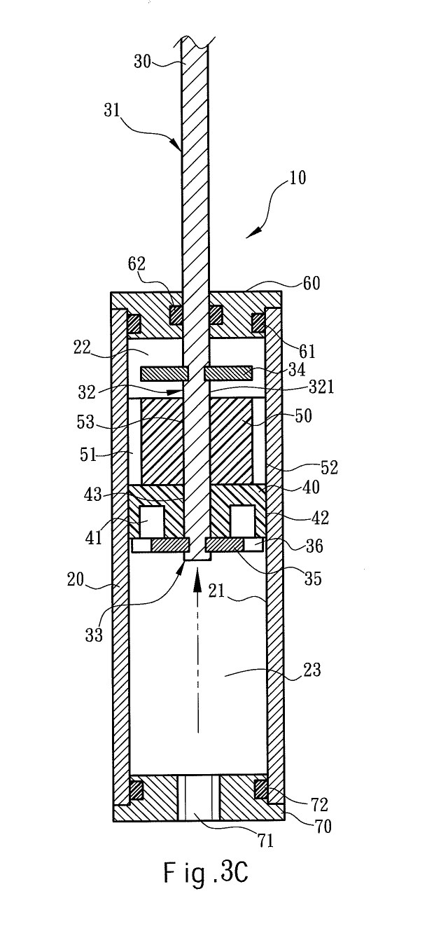

Refer to FIGS. 3A through 3C for the first embodiment in continuous moving conditions. When the air pressure buffer 10 is in the condition shown in FIG. 3A, the shaft 30 is pushed to move downwards by an external force, the closed space 22 is enlarged instantly, the air pressure per unit of area sustained by the lateral side of the valve 40 from the closed space 22 is dropped abruptly, the air pressure in the open space 23 pushes the outer surface 42 of the valve 40 outwards to press the inner wall 21 of the tube 20 to form a tighter coupling while the inner surface 43 of the valve 40 is slid on the shaft surface 321 to squeeze the compression member 50, and the compression member 50 is retained by the first retaining member 34 and deformed outwards to squeeze the inner wall 21 of the tube 20 to form an even tighter coupling as shown in FIG. 3B. Thus the valve 40 and the compression member 50 are used to enhance buffer damping for the downward moving shaft 30 to allow the shaft 30 to move steadily and slowly downwards. Other alternatives may be adopted to increase the buffer damping capability and effect previously discussed, such as forming a coarse surface on the outer surface 52 of the compression member 50, or greasing damping oil on the outer surface 52, or increasing the contact area between the outer surface 52 and the inner wall 21 of the tube 20. On the other hand, referring to FIG. 3B, when the shaft 30 is moved upwards by a reverse pulling force, the valve 40 and compression member 50 are quickly returned to their original shapes, the air pressure in the open space 23 pushes the valve 40 upwards to aid the shaft 30 to move upward as shown in FIG. 3C.

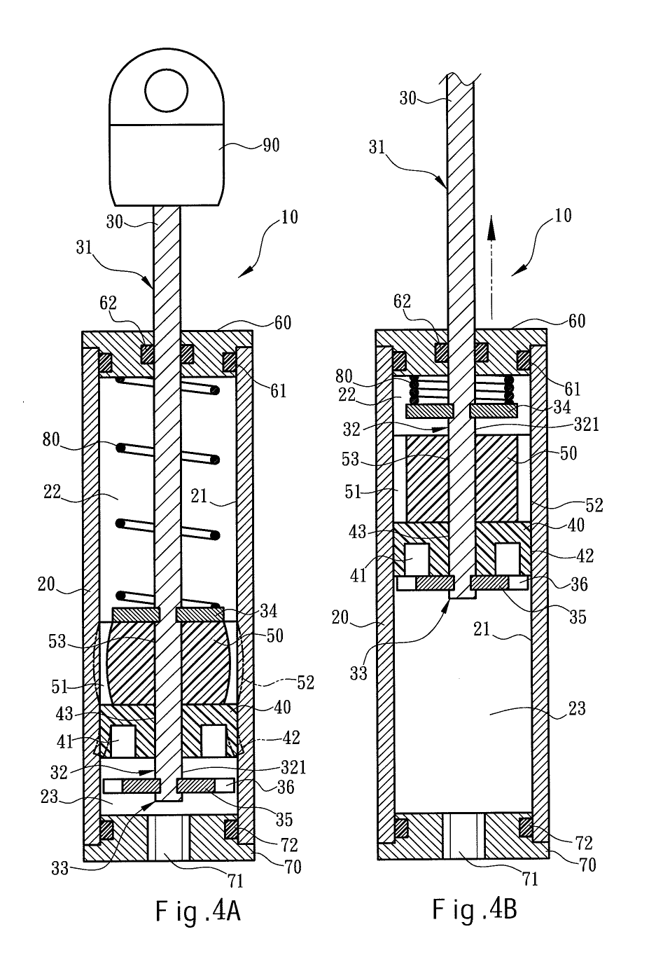

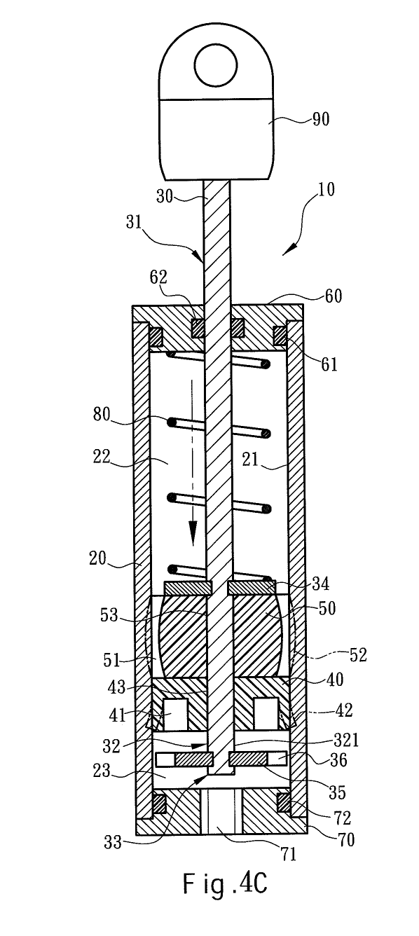

Refer to FIGS. 4A through 4C for a variation of the first embodiment by adding a compression spring in the closed space 22. A compression spring 80 is installed in the closed space 22 between the first cap 60 and first retaining member 34. When the shaft 30 is moved upwards by an external pulling force as shown in FIG. 4A, the pressure of the compression spring 80 is greater than that of the open space 23, hence the upward pulling force has to overcome the pressure of the compression spring 80 to make the valve 40 and compression member 50 to return quickly to their original shapes as shown in FIG. 4B with the shaft 30 being moved upwards. On the other hand, also referring to FIG. 4B, when the shaft 30 is moved downwards by reverse thrust, the outer surface 42 of the valve 40 is expanded outward to squeeze the inner wall 21 of the tube 20 to form a tighter coupling, and simultaneously compresses the compression member 50 to generate deformation outwards to squeeze the inner wall 21 of the tube 20 to form even tighter coupling as shown in FIG. 4C. Therefore, the valve 40 and compression member 50 are used to increase downward buffer damping for the shaft 30 being moved downwards steadily and slowly.

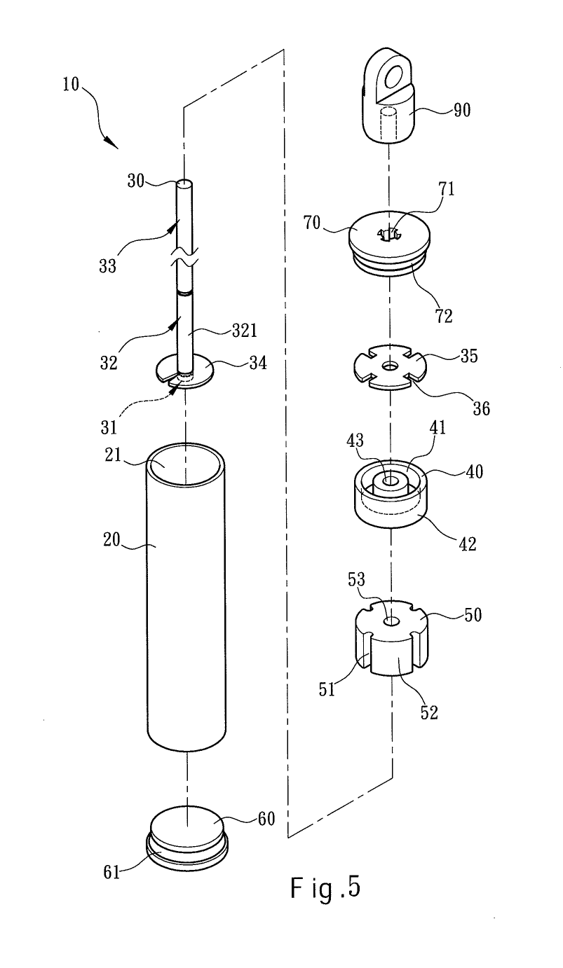

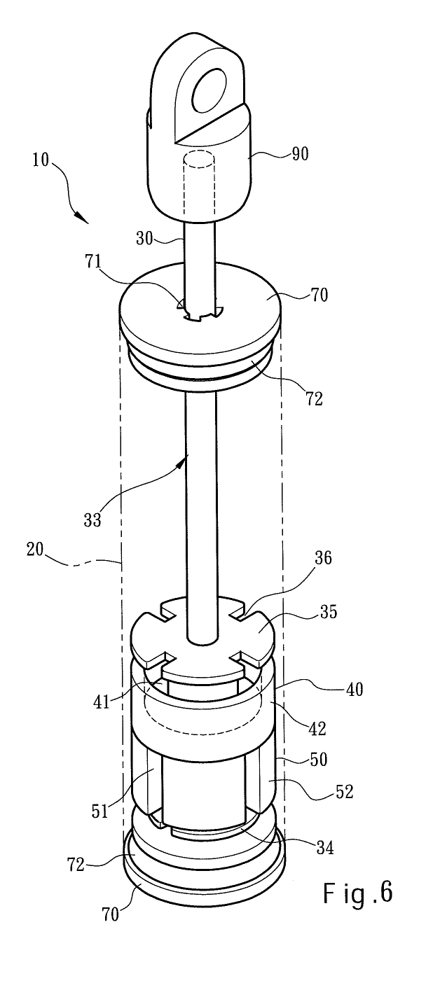

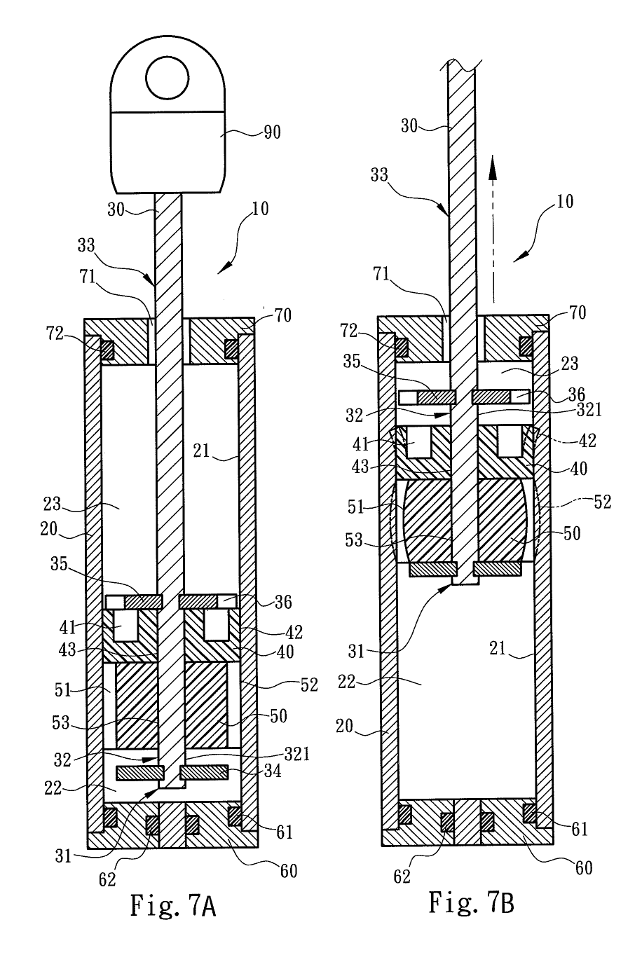

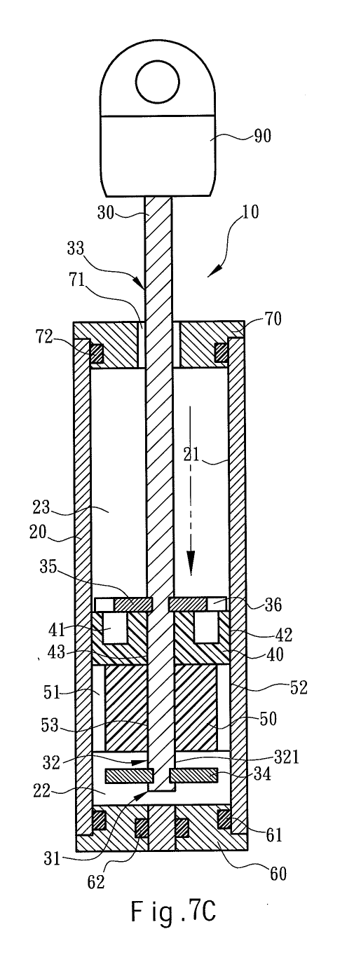

Please refer to FIGS. 5, 6 and 7A through 7C for a second embodiment of the invention. It differs from the first embodiment by having the third section 33 of the shaft 30 extended outside the tube 20 with other elements formed upside down. The closed space 22 is formed by tightly coupling the first cap 60 with the tube 20 without the second seal ring 62 in close contact with the first section 31. The third section 33 has a distal end extended outside the tube 20 to fasten to the connector 90. Refer to FIGS. 7A through 7C for the second embodiment in continuous moving conditions. When the air pressure buffer 10 is in the condition shown in FIG. 7A, the shaft 30 is moved upwards by an external pulling force, the pressure in the open space 23 pushes the outer surface 42 of the valve 40 outwards to press the inner wall 21 of the tube 20 to form a tighter coupling while the inner surface 43 of the valve 40 is slid on the shaft surface 321 to squeeze the compression member 50, and the compression member 50 is retained by the first retaining member 34 and deformed outwards to squeeze the inner wall 21 of the tube 20 to form even tighter coupling as shown in FIG. 7B. Thus the valve 40 and the compression member 50 are used to increase buffer damping for the upward moving shaft 30 to move steadily and slowly. On the other hand, referring to FIG. 7B, when the shaft 30 is moved downwards by reverse thrust, the valve 40 and compression member 50 are quickly returned to their original shapes, the pressure in the open space 23 pushes the valve 40 downwards to aid downward moving of the shaft 30 as shown in FIG. 7C.

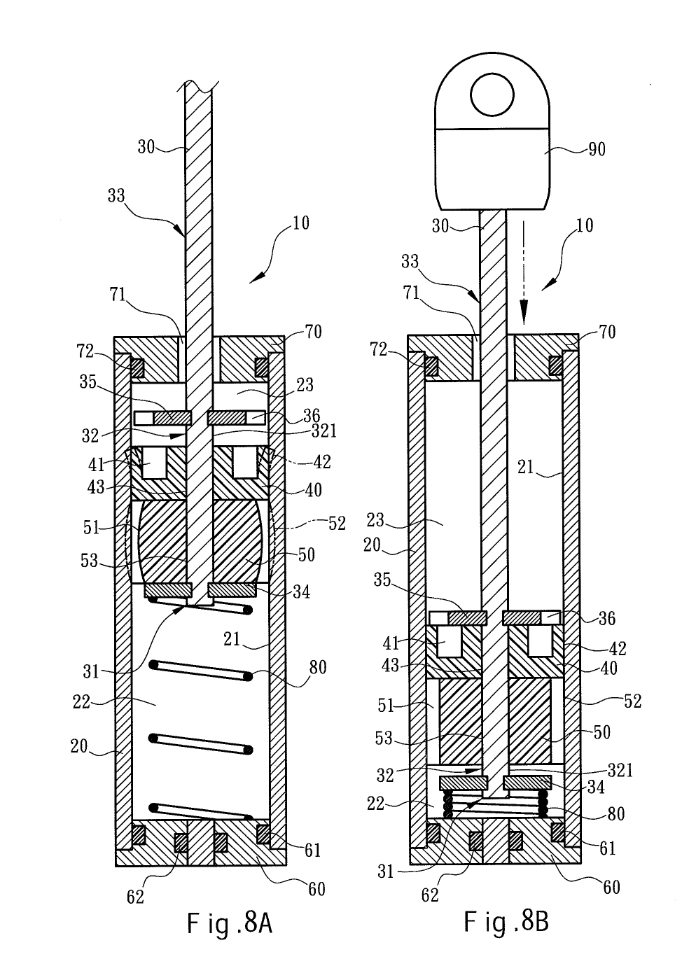

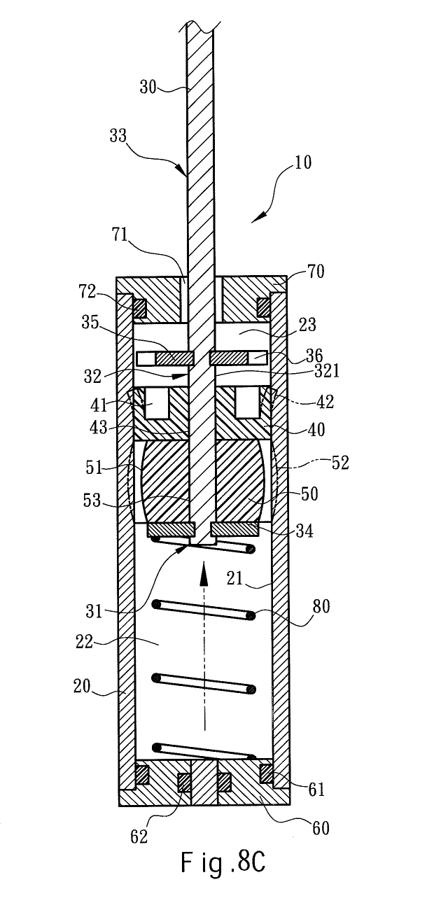

Refer to FIGS. 8A through 8C for a variation of the second embodiment by adding a compression spring in the closed space 22. A compression spring 80 is installed in the closed space 22 between the first cap 60 and first retaining member 34. When the shaft 30 is moved downwards by external thrust as shown in FIG. 8A, the pressure of the compression spring 80 is greater than that of the open space 23, hence the downward thrust has to overcome the pressure of the compression spring 80 to make the valve 40 and compression member 50 to return to their original shapes quickly as shown in FIG. 8B with the shaft 30 being moved downwards. On the other hand, also referring to FIG. 8B, when the shaft 30 is moved upwards by an inverse pulling force, the outer surface 42 of the valve 40 is expanded outwards to squeeze the inner wall 21 of the tube 20 to form a tighter coupling, and simultaneously compresses the compression member 50 to generate deformation outwards to squeeze the inner wall 21 of the tube 20 to form even tighter coupling as shown in FIG. 8C. Therefore, the valve 40 and compression member 50 are used to increase buffer damping for the upward moving shaft 30 to move steadily and slowly.

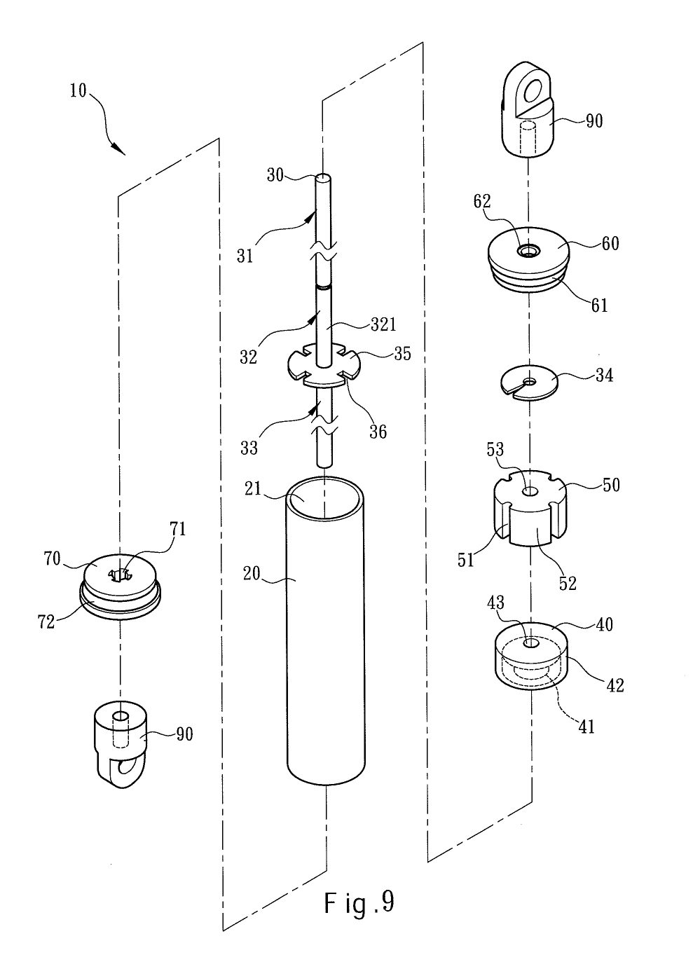

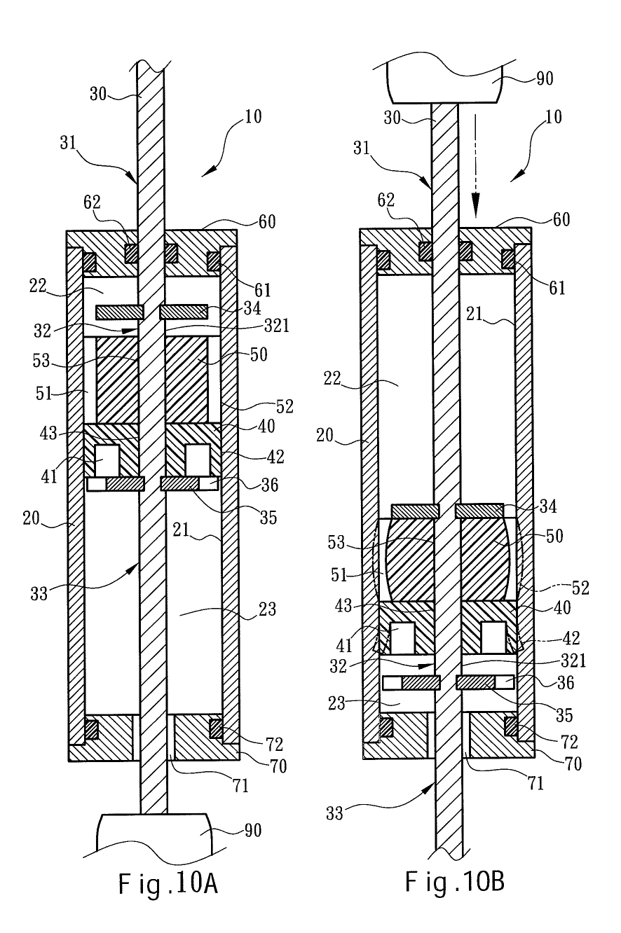

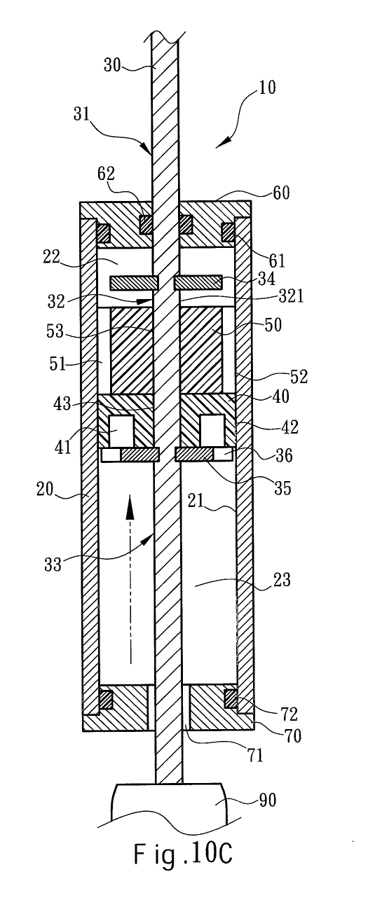

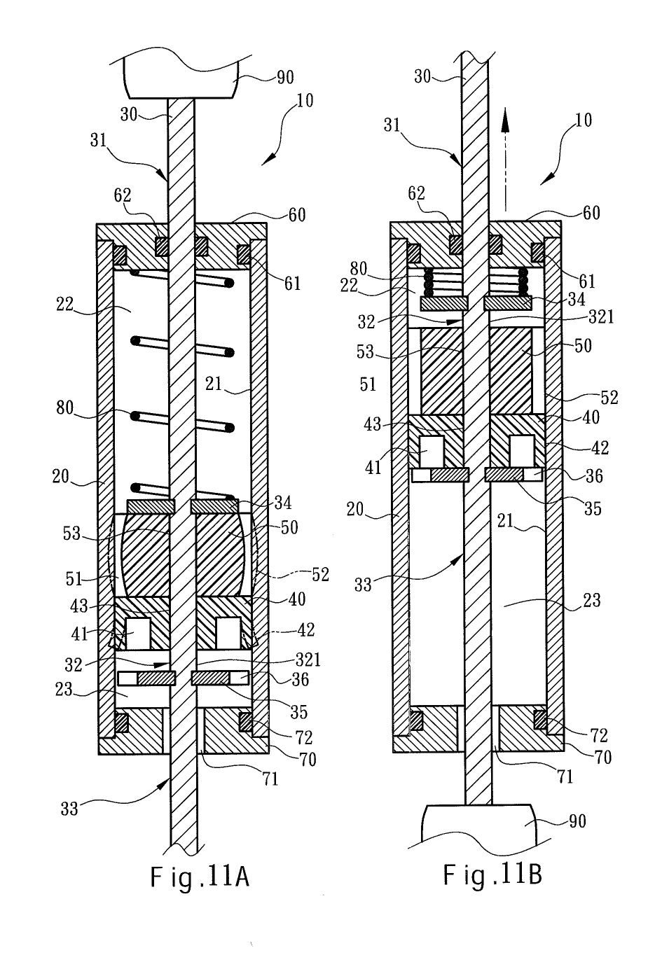

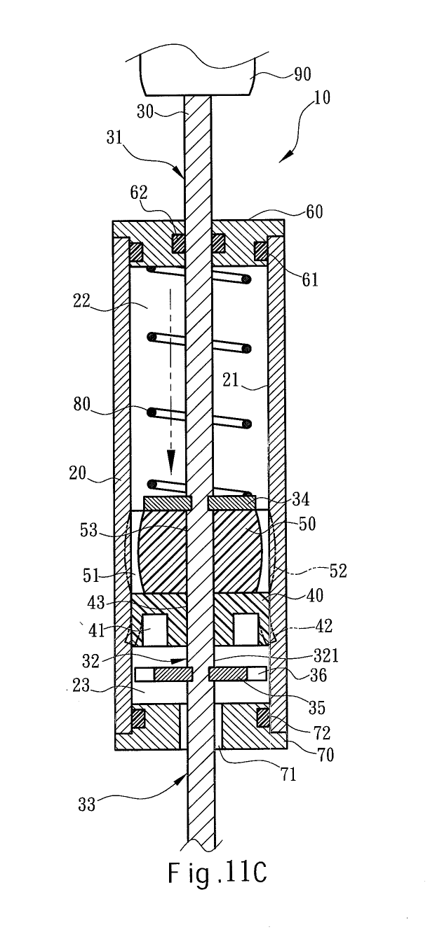

Please refer to FIGS. 9 and 10A through 10C for a third embodiment of the invention. It differs from the first embodiment by having the first section 31 and third section 33 extended outside the tube 20 that have respectively a distal end fastened to a connector 90. Refer to FIGS. 10A through 10C for the third embodiment in continuous moving conditions that are substantially the same as those previously discussed in FIGS. 3A through 3C, but it differs by allowing the external force to be selectively applied to the first section 31 and/or third section 33 of the shaft 30. FIGS. 11A through 11C illustrate a variation of the third embodiment by adding a compression spring in the closed space 22. A compression spring 80 is installed in the closed space 22 between the first cap 60 and first retaining member 34. The adopted technique and operation of the third embodiment are substantially the same as those discussed in FIGS. 4A through 4C, but it differs by allowing the external force to be selectively applied to the first section 31 and/or third section 33 of the shaft 30.

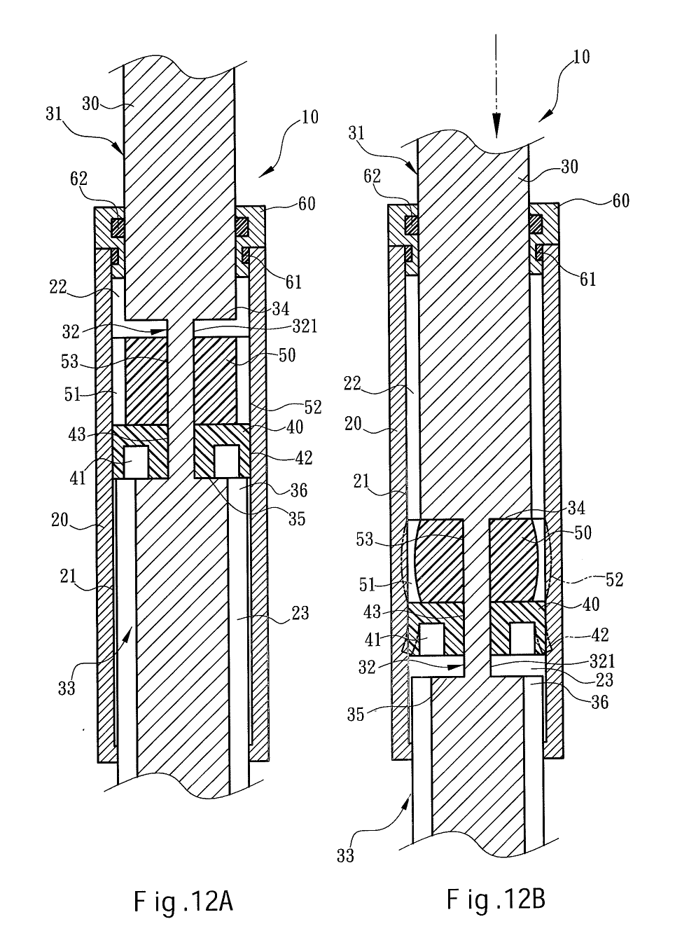

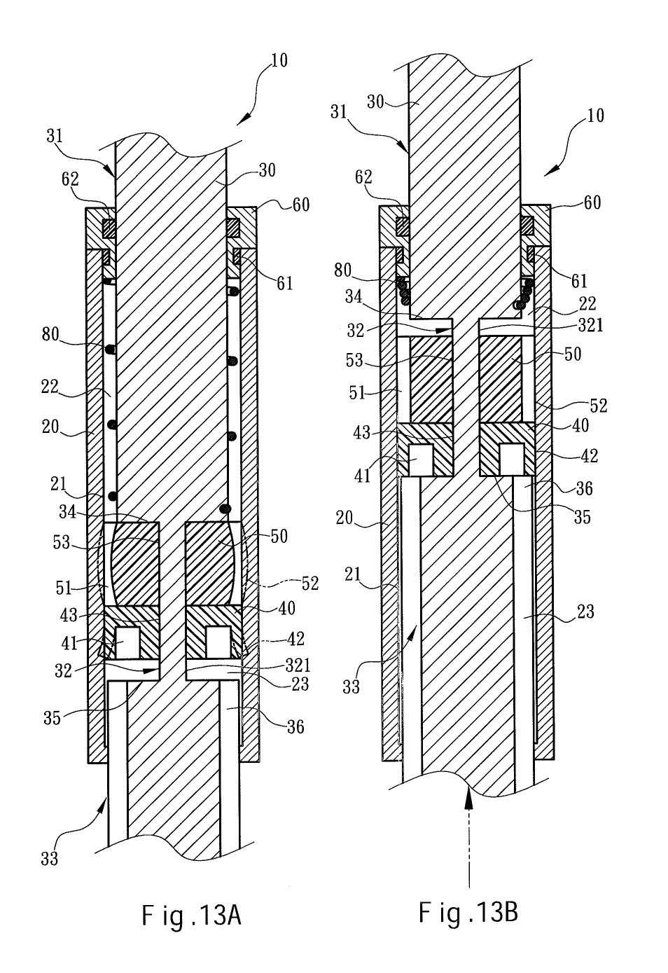

Please refer to FIGS. 12A and 12B for a fourth embodiment of the invention in continuous moving conditions. It is substantially the same as the one shown in FIGS. 10A and 10B, but it differs by integrating the first retaining member 34 and the first section 31 together, and also integrating the second retaining member 35 and third section 33 together without installing the second cap 70. FIGS. 13A and 13B illustrate a variation of the fourth embodiment by adding a compression spring in the closed space 22. A compression spring 80 is installed in the closed space 22 between the first cap 60 and first retaining member 34. The adopted technique and operation are substantially the same as those discussed in FIGS. 11A and 11B, but it differs by integrating the first retaining member 34 and the first section 31 together, and also integrating the second retaining member 35 and third section 33 together without installing the second cap 70.

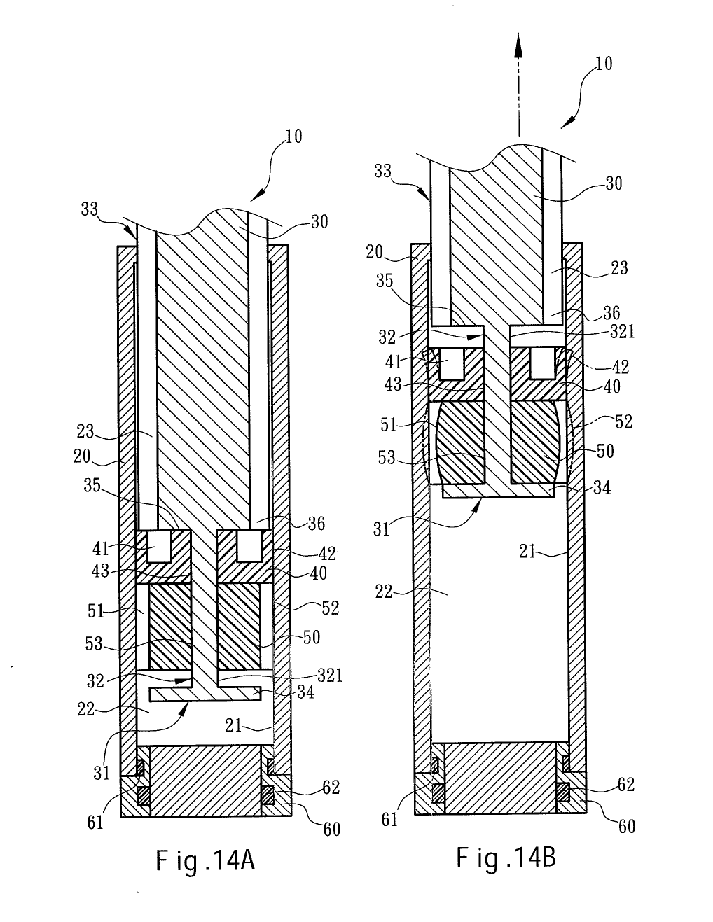

Please refer to FIGS. 14A and 14B for a fifth embodiment of the invention in continuous moving conditions. It is substantially the same as the one shown in FIGS. 7A and 7B, but it differs by integrating the first retaining member 34 and the first section 31 together, and also integrating the second retaining member 35 and third section 33 together without installing the second cap 70.

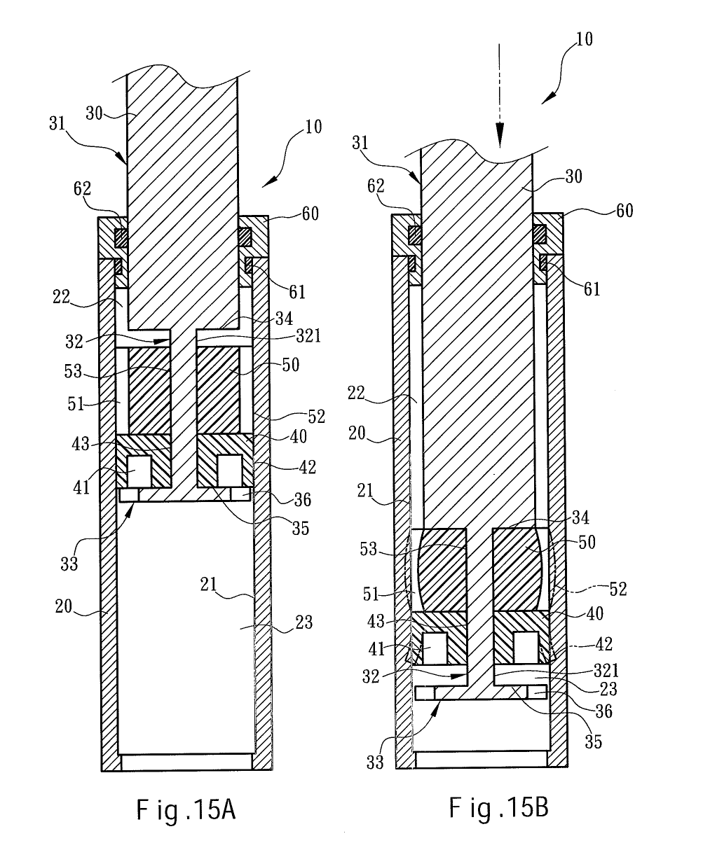

Refer to FIGS. 15A and 15B for a sixth embodiment of the invention in continuous moving conditions. It is substantially the same as the one shown in FIGS. 3A and 3B, but it differs by integrating the first retaining member 34 and the first section 31 together, and also integrating the second retaining member 35 and third section 33 together without installing the second cap 70

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. An air pressure buffer, comprising:
a hollow tube;
a first cap located at one end of the tube;
a shaft running through the tube and including a first section, a second section and a third section, the first and/or third sections being extended outside the tube;
a flexible valve which is held in the tube and surrounds the second section in an annular manner being formed at an outer diameter the same as an inner diameter of the tube and including an outer surface in contact with an inner wall of the tube in a sliding manner, and being formed at an inner diameter the same as an outer diameter of the second section and including an inner surface confined to be slid on a shaft surface of the second section, the valve also including one side formed an annular recess to form an open space with the tube and the second section extended to the third section and another side facing the first cap to form a closed space with the tube, the first cap, and the second section extended to the first section; and
a flexible compression member which is located in the closed space and surrounds the second section in an annular manner being formed at an outer diameter the same as the inner diameter of the tube and including an outer surface in contact with the inner wall of the tube in a sliding manner, and being formed at an inner diameter the same as the outer diameter of the second section and including an inner surface confined to be slid on the shaft surface of the second section, and also including at least one axial ventilation groove on the outer surface thereof.

2. The air pressure buffer of claim 1, wherein the tube includes another end coupled with a second cap which includes at least one aperture to allow the open space to communicate with outside of the tube.

3. The air pressure buffer of claim 1, wherein the shaft between the first section and the second section is coupled with an annular first retaining member which is formed at an outer diameter smaller than the outer diameter of the compression member and greater than or equal to an outer diameter of the first section.

4. The air pressure buffer of claim 2, wherein the shaft between the first section and the second section is coupled with an annular first retaining member which is formed at an outer diameter smaller than the outer diameter of the compression member and greater than or equal to an outer diameter of the first section.

5. The air pressure buffer of claim 1, wherein the shaft between the second section and the third section is coupled with an annular second retaining member which is formed at an outer diameter smaller than the outer diameter of the valve and greater than or equal to an outer diameter of the third section, the second retaining member including at least one notch to allow the recess to communicate with outside of the tube.

6. The air pressure buffer of claim 2, wherein the shaft between the second section and the third section is coupled with an annular second retaining member which is formed at an outer diameter smaller than the outer diameter of the valve and greater than or equal to an outer diameter of the third section, the second retaining member including at least one notch to allow the recess to communicate with outside of the tube.

7. The air pressure buffer of claim 3, wherein the shaft between the second section and the third section is coupled with an annular second retaining member which is formed at an outer diameter smaller than the outer diameter of the valve and greater than or equal to an outer diameter of the third section, the second retaining member including at least one notch to allow the recess to communicate with outside of the tube.

8. The air pressure buffer of claim 4, wherein the shaft between the second section and the third section is coupled with an annular second retaining member which is formed at an outer diameter smaller than the outer diameter of the valve and greater than or equal to an outer diameter of the third section, the second retaining member including at least one notch to allow the recess to communicate with outside of the tube.

9. The air pressure buffer of claim 1 further comprising a compression spring held in the closed space between the first cap and the first retaining member.

10. The air pressure buffer of claim 2 further comprising a compression spring held in the closed space between the first cap and the first retaining member.

11. The air pressure buffer of claim 3 further comprising a compression spring held in the closed space between the first cap and the first retaining member.

12. The air pressure buffer of claim 4 further comprising a compression spring held in the closed space between the first cap and the first retaining member.

13. The air pressure buffer of claim 5 further comprising a compression spring held in the closed space between the first cap and the first retaining member.

14. The air pressure buffer of claim 6 further comprising a compression spring held in the closed space between the first cap and the first retaining member.

15. The air pressure buffer of claim 7 further comprising a compression spring held in the closed space between the first cap and the first retaining member.

16. The air pressure buffer of claim 8 further comprising a compression spring held in the closed space between the first cap and the first retaining member.
